(19) United States
(12) Patent Application Publication
(10) Pub. No.: US 2014/0074927 A1
(43) Pub. Date: Mar. 13, 2014

(54) CACHING CONTENT BASED ON SOCIAL NETWORK RELATIONS

(71) Applicants: Adrian X. Rodriguez, Durham, NC (US); Nicholas R. Sandonato, Raleigh, NC (US); Ian C. Tewksbury, Morrisville, NC (US)

(72) Inventors: Adrian X. Rodriguez, Durham, NC (US); Nicholas R. Sandonato, Raleigh, NC (US); Ian C. Tewksbury, Morrisville, NC (US)

(73) Assignee: INTERNATIONAL BUSINESS MACHINES CORPORATION, Armonk, NY (US)

(21) Appl. No.: 13/614,540

(22) Filed: Sep. 13, 2012

(51) Int. Cl. G06F 15/16

(52) U.S. Cl. 709/204

(57) ABSTRACT

Various embodiments provide for use of social networking postings to predict (e.g., where and when) caching of content (e.g., social network related content) would be beneficial (e.g., to speed access). In one example, the caching may be performed by one or more Internet Service Providers (ISPs), one or more content providers and/or one or more content distributors. In one specific example, one or more Internet Service Providers (ISPs), one or more content providers and/or one or more content distributors may be local ISPs.

### BACKGROUND

The present disclosure relates generally to the field of caching content based on social network relations.

In various examples, caching content based on social network relations may be implemented in the form of systems, methods and/or algorithms.

Social networks are useful for making information (e.g., websites, videos, news, music, pictures) available to large groups of people. Although information is known about social networking partners in such social networks, little is typically done to optimize the content delivery (network and content cache is conventionally based on historic information and trends).

### SUMMARY

In various embodiments, methodologies may be provided that automatically predict where and when to cache content based on social network relations. Further, in various embodiments, methodologies may be provided that automatically cache content based on social network relations.

In another embodiment, a method implemented in a computer system for caching content identified by at least a first member of a social network comprising a plurality of members is provided, the method comprising: determining, with the computer system, that the first member has identified the content, wherein the content identified by the first member is stored at a first storage geographic location; determining, with the computer system, that the first member has a relationship with at least a second member of the social network such that the first and second members are social networking partners; determining, with the computer system, a geographic location of the second member; and caching with the computer system, at a second storage geographic location, the content identified by the first member, wherein the second storage geographic location is geographically closer to the determined geographic location of the second member than the first storage geographic location is to the determined geographic location of the second member.

In another embodiment, a computer readable storage medium, tangibly embodying a program of instructions executable by the computer for caching content identified by at least a first member of a social network comprising a plurality of members is provided, the program of instructions, when executing, performing the following steps: determining, with the computer, that the first member has identified the content, wherein the content identified by the first member is stored at a first storage geographic location; determining, with the computer, that the first member has a relationship with at least a second member of the social network such that the first and second members are social networking partners; determining, with the computer, a geographic location of the second member; and caching with the computer, at a second storage geographic location, the content identified by the first member, wherein the second storage geographic location is geographically closer to the determined geographic location of the second member than the first storage geographic location is to the determined geographic location of the second member.

In another embodiment, a computer-implemented system for caching content identified by at least a first member of a social network comprising a plurality of members is provided, the system comprising: an input element configured to receive data; a determining element in operative communication with the input element configured to determine, based at least in part upon the received data: (a) that the first member has identified the content, wherein the content identified by the first member is stored at a first storage geographic location; (b) that the first member has a relationship with at least a second member of the social network such that the first and second members are social networking partners; and (c) a geographic location of the second member; and a caching element in operative communication with the determining element configured to cache, at a second storage geographic location, the content identified by the first member, wherein the second storage geographic location is geographically closer to the determined geographic location of the second member than the first storage geographic location is to the determined geographic location of the second member.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a flowchart of a method according to an embodiment of the present invention.

FIG. 2 depicts a block diagram of a system according to an embodiment of the present invention.

FIG. 3 depicts a block diagram of a system according to an embodiment of the present invention.

FIG. 4 depicts a block diagram of a system according to an embodiment of the present invention.

### DETAILED DESCRIPTION

In one example, one or more systems, methods and/or algorithms may provide for automatically predicting where and when to cache content based on social network relations.

In another example, one or more systems, methods and/or algorithms may provide for automatically caching content based on social network relations.

For the purposes of describing and claiming the present invention the term “social network” is intended to refer to a grouping of people according to one or more relationships between and/or among them. In one example, a social network may include a plurality of members and may be organized and maintained via a computer system.

For the purposes of describing and claiming the present invention the term “social networking partners” is intended to refer to two or more people in a social network who are related in some manner. In various examples, such relationships may be as family, as friends, as colleagues, as associates, as “a friend of a friend”, as graduates of the same school and/or any other desired feature or characteristic.

As described herein, various embodiments provide for use of social networking postings to predict (e.g., where and when) caching of content (e.g., social network related content) would be beneficial (e.g., to speed access). In one example, the caching may be performed by one or more Internet Service Providers (ISPs). In one specific example, one or more of the ISPs may be local ISPs. In another example, the caching may be performed by one or more content providers. In one specific example, one or more of the content providers may be local content providers. In another example, the caching may be performed by one or more content distributors. In one specific example, one or more of the content distributors may be local content distributors.

In one specific example, a mechanism may operate as follows: (a) a link (e.g., a website link) is shared on a social network (e.g., a social network website); (b) the computer system maintaining the social network makes the link (along with information about actual and/or potential viewers of the link) available to one or more ISPs and/or one or more content providers and/or one more content distributors (in one example, this information may include (but not be limited to): general geographic location(s), number of people at each location, likelihood of the people clicking on the link); (c) the ISP(s) and/or content provider(s) and/or content distributor(s) may then cache the content (e.g., website, image, video, text file) pointed to by the link in close proximity (e.g., geographically close proximity) to the potential viewers before such potential viewers request the content; (d) eventually, social networking partners of the user that shared the link may request to view the content posted; (e) the content will have already been cached in close proximity (e.g., geographically close proximity) to these viewers before they decided to view the content; and/or (f) as links are re-shared and branch into different social circles, the ISP(s) and/or content provider(s) and/or content distributor(s) may gain this knowledge and can adapt as various steps repeat.

In one example, close proximity may be within the same city or within the same state or within an arbitrary boundary. In another example, close proximity may be within a defined (e.g., predefined) range, distance or threshold.

In another example, the social network information may also be used to determine when to cause a cache to expire (e.g., once all of the social networking partners have viewed the cached content and it is unlikely that they will view the cached content again).

As described herein, actual geographic information about data consumers (e.g., social networking partners) may be used to predict (and/or trace) content flow. In one example, certain ISP(s) and/or content provider(s) and/or content distributor(s) located geographically closer to the mass of collective data consumers than such ISP(s) and/or content provider(s) and/or content distributor(s) are located to an original data source can be primed with the data (instead of, for example, the data being pre-fetched at the data consumer level). For example, user A may share an article from his favorite news site. Ninety percent of user A's social networking partners are located in the Raleigh area (though user A may not be). The relevant ISP(s) and/or content provider(s) and/or content distributor(s) can be notified by a computer system maintaining the social network to cache this news site data closer to the point(s) where mass requests may come from (that is, cache this news site data closer to the point(s) where mass requests may come from than the location of the original data source). This way, whenever requests start coming in from the target location, data is already cached by the relevant ISP(s) and/or content provider(s) and/or content distributor(s). This can keep spreading geographically ad infinitum. This geographic spreading of information can also be used preemptively by the ISP(s) and/or content provider(s) and/or content distributor(s) if a trend is noticed in the way data works its way around. The ISP(s) and/or content provider(s) and/or content distributor(s) can then plan, for example, to cache the data (e.g., immediately) upon the initial release of the data to coincide with typical dissemination trends.

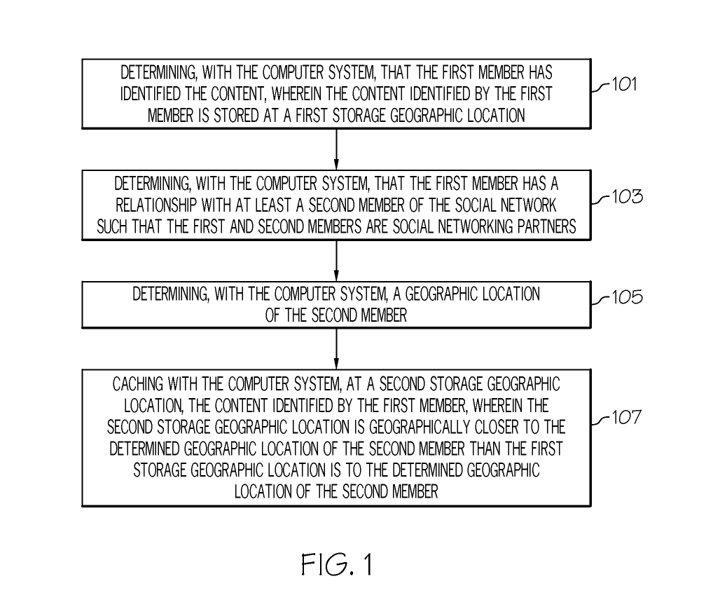

Referring now to FIG. 1, a method implemented in a computer system for caching content identified by at least a first member of a social network comprising a plurality of members is shown. As seen in this FIG. 1, the method of this embodiment comprises: at 101—determining, with the computer system, that the first member has identified the content, wherein the content identified by the first member is stored at a first storage geographic location (e.g., comprising a computer memory, a database and/or the like); at 103—determining, with the computer system, that the first member has a relationship with at least a second member of the social network such that the first and second members are social networking partners; at 105—determining, with the computer system, a geographic location of the second member; and at 107—caching with the computer system, at a second storage geographic location (e.g., comprising a computer memory, a database and/or the like), the content identified by the first member, wherein the second storage geographic location is geographically closer to the determined geographic location of the second member than the first storage geographic location is to the determined geographic location of the second member.

In one example, a location (e.g., a geographic location of a user) may be determined by mapping of an IP address of the user's computer to a geographic location.

In another example, a location (e.g., a geographic location of a user) may be determined by referring to a profile or the like associated with the user (e.g., a social network profile indicating a home address and/or a work address).

In another example, another mechanism that could be used to determine geography is where a potential viewer made his/her last post or status update from. For example, in Facebook (™) you can choose to include your location when you make a post or status update (e.g., “Like—Comment—Share—56 minutes ago near Pittsburgh, Pa.”). Or you can even ‘check-in’ at a location. This would be an indicator of geographic location.

In one example, any steps may be carried out in the order recited or the steps may be carried out in another order.

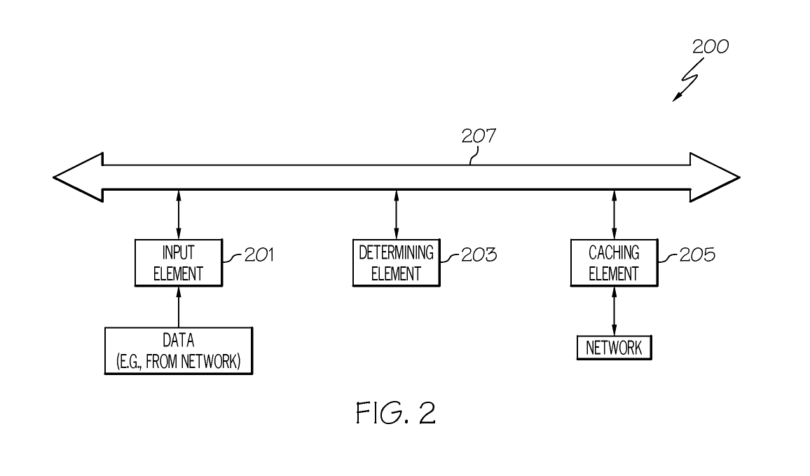

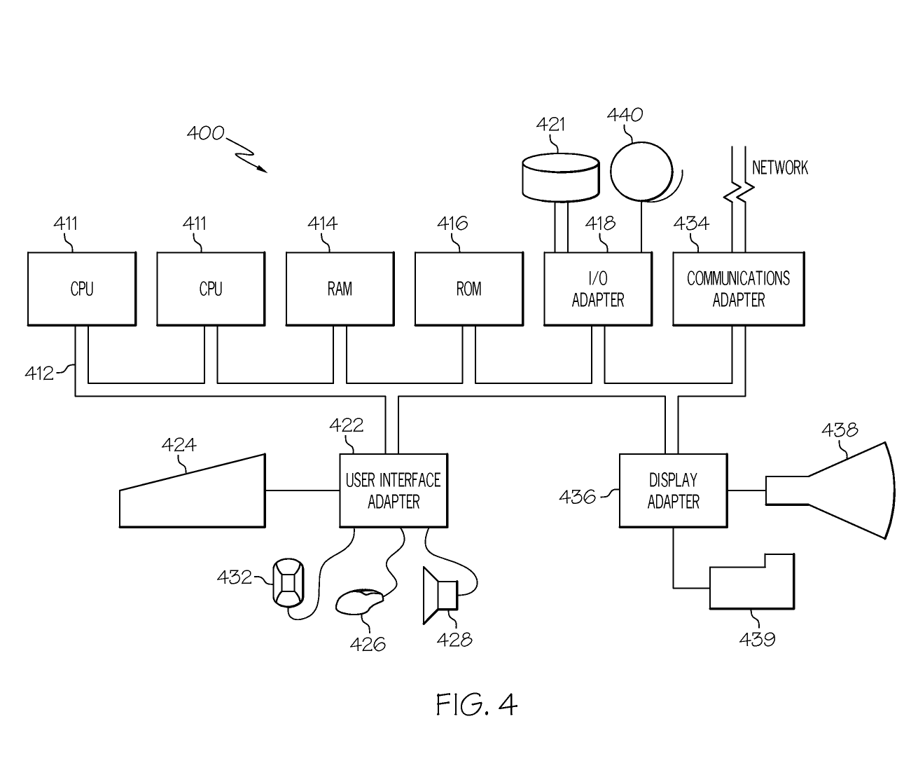

Referring now to FIG. 2, in another embodiment, a system 200 for caching content identified by at least a first member of a social network comprising a plurality of members is provided. This system may include the following elements: an input element 201 configured to receive data (e.g., data indicative of content identified by the first member, data indicative of a geographic location of content identified by the first member, data indicative of a social networking partners relationship between the first member and a second member and/or data indicative of a geographic location of the second member); a determining element 203 in operative communication with the input element 201 configured to determine: (a) that the first member has identified the content, wherein the content identified by the first member is stored at a first storage geographic location (e.g., comprising a computer memory, a database and/or the like); (b) that the first member has a relationship with at least a second member of the social network such that the first and second members are social networking partners; and (c) a geographic location of the second member; and a caching element 205 in operative communication with the determining element 203 configured to cache, at a second storage geographic location (e.g., comprising a computer memory, a database and/or the like), the content identified by the first member, wherein the second storage geographic location is geographically closer to the determined geographic location of the second member than the first storage geographic location is to the determined geographic location of the second member. Each of the input element 201, the determining element 203 and the caching element 205 may be operatively connected together via system bus 207. In one example, communication between and among the various elements may be bi-directional. In another example, the communication may be carried out via the Internet, an intranet, a local area network, a wide area network and/or any other desired communication channel(s). In another example, some or all of these elements may be implemented in a computer system of the type shown in FIG. 4.

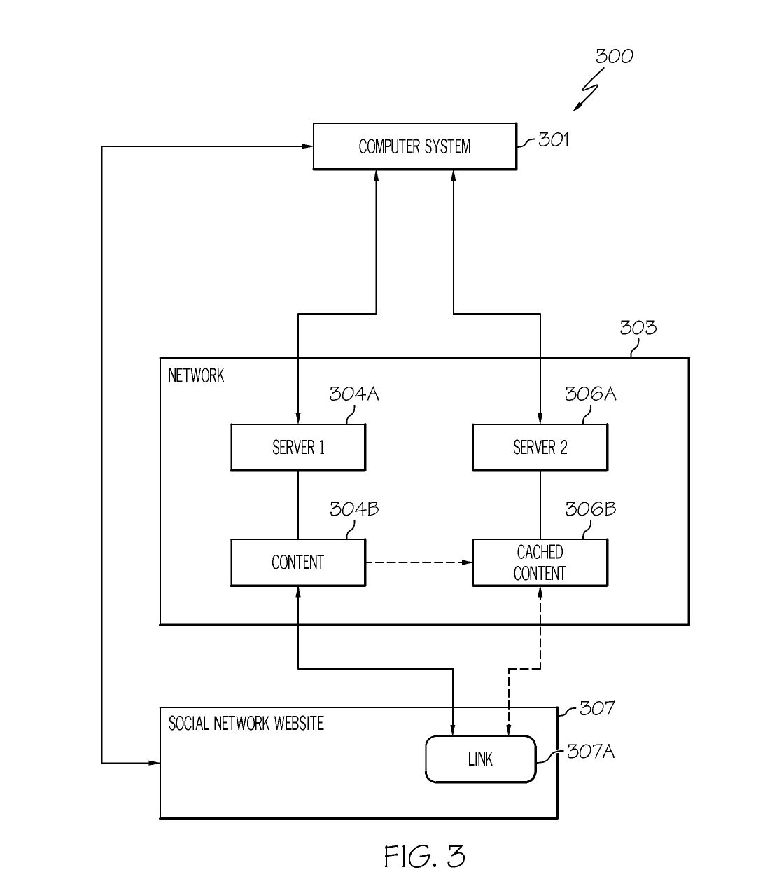

Referring now to FIG. 3, in another embodiment, a system 300 for caching content identified by at least a first member of a social network comprising a plurality of members is provided. As seen in this FIG. 3, computer system 301 communicates with network 303 (in one example, computer system 301 may comprise elements 201, 203, 205 and 207 if FIG. 2).

Still referring to FIG. 3, it is seen that network 303 may comprise server 1 (identified by call-out number 304A) and server 2 (identified by call-out number 306A). Of course, while this example shows two servers as forming network 303, any desired number of servers may form network 303. Further, it is seen that server 1 has stored thereon (e.g., comprising a computer memory, a database and/or the like) content 304B and server 2 has stored thereon (e.g., comprising a computer memory, a database and/or the like) cached content 306B. As described in more detail below, the cached content 306B is copied from server 1 to server 2 as directed by computer system 301. In another example, some or all of these elements may be implemented in a computer system of the type shown in FIG. 4.

Still referring to FIG. 3, it is seen that social network website 307 initially includes link 307A to content 304B. As operation progresses, however, and computer system 301 directs the copying of content 304B to server 2 as cached content 306B (see the dashed line associated with server 1 and server 2), link 307A may be directed instead (or additionally to) cached content 306B on server 2. In one example, for a first user (e.g., located at a first geographic location), link 307A may point to content 304B on server 1 (see the solid line between link 307A and content 304B) and for a second user (e.g., located at a second geographic location different from the first geographic location), link 307A may point to content 306B on server 2 (see the dashed line between link 307A and cached content 306B). In one example, customized websites and/or customized links may be provided to each of the first user and the second user. In another example, a redirection process or the like may be employed to direct a link associated with the first user to server 1 and a link associated with the second user to server 2).

Referring now to FIG. 4, this figure shows a hardware configuration of computing system 400 according to an embodiment of the present invention. As seen, this hardware configuration has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communications adapter 434 for connecting the system 400 to a data processing network, the Internet, an intranet, a local area network (LAN), etc., and a display adapter 436 for connecting the bus 412 to a display device 438 and/or printer 439 (e.g., a digital printer or the like).

Of note, while various figures may show various entities communicating, it is to be understood that the figures are actually referring to communication by computer system(s) or the like that are owned, leased, operated, used by, in the possession of, and/or controlled by each of the entities.

As described herein, various mechanisms provide for caching web content based on location information of recipients of an electronic communication consisting of a link to the web content. In one example, various mechanisms provide for predicting a number of potential viewers of a link to web content shared with one or more viewers and providing the link and social network information of potential viewers (e.g., number of viewers, location of viewers, interest of viewers) to one or more ISP(s) and/or content provider(s) and/or content distributor(s) for location-based caching.

As described herein, various mechanisms provide for predicting one or more content requests (e.g., one or more web content requests) based on dissemination of social network information (e.g., social network relationships) and/or and allocating one or more caches (for holding the content) based on dissemination of social network information (e.g., social network relationships) and/or storing the content in one or more caches based on dissemination of social network information (e.g., social network relationships).

In one embodiment, a mechanism is provided for predicting content requests and allocating one or more caches based on dissemination of social network information, the mechanism comprising: a link having content associated therewith; a social network having potential viewers of the link interconnected via a computer system maintaining the social network; one or more ISP(s) and/or content provider(s) and/or content distributor(s) to which the link is made available via the computer system maintaining the social network; and social network information about the potential viewers of the link (e.g., number of potential viewers, location(s) of potential viewers, interest tendencies of potential viewers, likelihood of potential viewers clicking on a given link) provided to the ISP(s) and/or content provider(s) and/or content distributor(s) via the computer system maintaining the social network; wherein content designated of interest to the potential viewers based on the social network information is cached and/or posted by the ISP(s) and/or content provider(s) and/or content distributor(s) and made available to the potential viewers prior to the potential viewers requesting the content.

In one example, the available cached and/or posted content adapts as the link is shared and/or the social circle of the potential viewers changes.

In another example, the cached and/or posted content expires when the social network information determines that the potential viewers are unlikely to access the designated content.

As described herein, various mechanisms may use real-time postings to a computer system maintaining a social network to allow the ISP(s) and/or content provider(s) and/or content distributor(s) to predict network traffic and adjust capacity accordingly.

In another embodiment, if a user logs in from his computer and searches for and reads, for example, a Wikipedia (™) article, the location of the user's computer is known by Wikipedia (™) (e.g., via mapping of an IP address of the user's computer to a geographic location). Wikipedia (™) (and/ or any other desired organization and/or system) can then measure public instances of the information (that is, the information searched for and/or read) being posted externally (e.g., to Twitter (™), to Facebook (™), to Digg (™), to Slashdot (™)) and link the initial search with the external publication of information. The spread of information can thus be tracked (e.g., based on the requests from people within a given social network).

In one specific example, operation may be as follows: A user will post a news story to his social networking partners (e.g., “friends”) on a social network (e.g., Facebook). Because, for example, 90% of that the user's friends are in Raleigh, the relevant ISP(s) and/or content provider(s) and/or content distributor(s) could make the assumption that now other people in Raleigh will start requesting the same news post and because of this the relevant ISP(s) and/or content provider(s) and/or content distributor(s) could create a local cache of the post in Raleigh to improve the fetch time of that story for other people in the same social network as the original poster. As the news article is viewed across the original poster's social network the news article then may jump to a new geographic area and start spreading around the social circles in that area where another local cache could be created. Using such social graph information to predict network demand of certain information could improve the response time for content requests.

In one specific example, feedback about a user's post(s)(e.g., a user's status update(s) (such as associated with Twitter(™) or Tumblr(™)) or a user's wall posts such as associated with Facebook(™)) and the profiles of the user's social networking partners (e.g., “friends”) are all public. Once a given user “likes” certain content, the relevant ISP(s) and/or content provider(s) and/or content distributor(s) will be notified that the person likes that content. Thus, any available information (e.g., publically available information) about that person and that person's social networking partners (e.g., “friends”) may be used for cache management.

In another example, the mechanism may be extended to model the flow of information from one person to another and across the social network (e.g., between and/or among social networking partners). For example, the flow of information across a map (e.g., a region) can be tracked by the social networking feeds and aggregated with geographic data from physical systems. This could be used, for example, to credit initial contributors for spreading data (e.g., credit can be given to those users that spread the information and/or that led to the most impressions and/or clicks).

As described herein, various embodiments provide geographic caching based on potential and/or actual access from socially-linked users. In one example, the caching may be proactive based on knowing where content may be accessed from.

In another embodiment, a method implemented in a computer system for caching content identified by at least a first member of a social network comprising a plurality of members is provided, the method comprising: determining, with the computer system, that the first member has identified the content, wherein the content identified by the first member is stored at a first storage geographic location; determining, with the computer system, that the first member has a relationship with at least a second member of the social network such that the first and second members are social networking partners; determining, with the computer system, a geographic location of the second member; and caching with the computer system, at a second storage geographic location, the content identified by the first member, wherein the second storage geographic location is geographically closer to the determined geographic location of the second member than the first storage geographic location is to the determined geographic location of the second member.

In one example, the content is identified by a link posted on a social network website.

In another example, the link is posted on the social network website by the first member.

In another example, the content comprises at least one file selected from the group including: (a) at least one multimedia file; (b) at least one video file; (c) at least one audio file; (d) at least one image file; and (d) at least one webpage.

In another example, the existence of the social networking partners relationship that the first member has with the second member is determined by examining data associated with the first member that is stored on the social network and data associated with the second member that is stored on the social network.

In another example, the geographic location of the second member is determined by examining data associated with the second member that is stored on the social network.

In another example, the computer system causes the cached content to expire.

In another example: the determining that the first member has a relationship with at least the second member further comprises determining that the first member has a relationship with the second member and a third one of the members such that the first and second members are social networking partners and the first and third members are social networking partners; the determining a geographic location of the second member further comprises determining a geographic location of the second member and a geographic location of the third member; and the second storage geographic location where the content is cached is geographically closer to both the determined geographic location of the second member and the determined geographic location of the third member than the first storage geographic location is to either of the determined geographic location of the second member and the determined geographic location of the third member.

In another embodiment, a computer readable storage medium, tangibly embodying a program of instructions executable by the computer for caching content identified by at least a first member of a social network comprising a plurality of members is provided, the program of instructions, when executing, performing the following steps: determining, with the computer, that the first member has identified the content, wherein the content identified by the first member is stored at a first storage geographic location; determining, with the computer, that the first member has a relationship with at least a second member of the social network such that the first and second members are social networking partners; determining, with the computer, a geographic location of the second member; and caching with the computer, at a second storage geographic location, the content identified by the first member, wherein the second storage geographic location is geographically closer to the determined geographic location of the second member than the first storage geographic location is to the determined geographic location of the second member.

In one example, the content is identified by a link posted on a social network website.

In another example, the link is posted on the social network website by the first member.

In another example, the content comprises at least one file selected from the group including: (a) at least one multimedia file; (b) at least one video file; (c) at least one audio file; (d) at least one image file; and (d) at least one webpage.

In another example, the existence of the social networking partners relationship that the first member has with the second member is determined by examining data associated with the first member that is stored on the social network and data associated with the second member that is stored on the social network.

In another example, the geographic location of the second member is determined by examining data associated with the second member that is stored on the social network.

In another example, the computer causes the cached content to expire.

In another example: the determining that the first member has a relationship with at least the second member further comprises determining that the first member has a relationship with the second member and a third one of the members such that the first and second members are social networking partners and the first and third members are social networking partners; the determining a geographic location of the second member further comprises determining a geographic location of the second member and a geographic location of the third member; and the second storage geographic location where the content is cached is geographically closer to both the determined geographic location of the second member and the determined geographic location of the third member than the first storage geographic location is to either of the determined geographic location of the second member and the determined geographic location of the third member.

In another embodiment, a computer-implemented system for caching content identified by at least a first member of a social network comprising a plurality of members is provided, the system comprising: an input element configured to receive data; a determining element in operative communication with the input element configured to determine, based at least in part upon the received data: (a) that the first member has identified the content, wherein the content identified by the first member is stored at a first storage geographic location; (b) that the first member has a relationship with at least a second member of the social network such that the first and second members are social networking partners; and (c) a geographic location of the second member; and a caching element in operative communication with the determining element configured to cache, at a second storage geographic location, the content identified by the first member, wherein the second storage geographic location is geographically closer to the determined geographic location of the second member than the first storage geographic location is to the determined geographic location of the second member.

In one example, the content is identified by a link posted on a social network website.

In another example, the link is posted on the social network website by the first member.

In another example, the content comprises at least one file selected from the group including: (a) at least one multimedia file; (b) at least one video file; (c) at least one audio file; (d) at least one image file; and (d) at least one webpage.

In another example, the existence of the social networking partners relationship that the first member has with the second member is determined by examining data associated with the first member that is stored on the social network and data associated with the second member that is stored on the social network.

In another example, the geographic location of the second member is determined by examining data associated with the second member that is stored on the social network.

In another example, the computer system causes the cached content to expire.

In another example: the determining that the first member has a relationship with at least the second member further comprises determining that the first member has a relationship with the second member and a third one of the members such that the first and second members are social networking partners and the first and third members are social networking partners; the determining a geographic location of the second member further comprises determining a geographic location of the second member and a geographic location of the third member; and the second storage geographic location where the content is cached is geographically closer to both the determined geographic location of the second member and the determined geographic location of the third member than the first storage geographic location is to either of the determined geographic location of the second member and the determined geographic location of the third member.

In other examples, predicting web content request(s) based on one or more social network relations may be provided.

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

What is claimed is:

1. A method implemented in a computer system for caching content identified by at least a first member of a social network comprising a plurality of members, the method comprising:
determining, with the computer system, that the first member has identified the content, wherein the content identified by the first member is stored at a first storage geographic location;
determining, with the computer system, that the first member has a relationship with at least a second member of the social network such that the first and second members are social networking partners;
determining, with the computer system, a geographic location of the second member; and
caching with the computer system, at a second storage geographic location, the content identified by the first member, wherein the second storage geographic location is geographically closer to the determined geographic location of the second member than the first storage geographic location is to the determined geographic location of the second member.

2. The method of claim 1, wherein the content is identified by a link posted on a social network website.

3. The method of claim 2, wherein the link is posted on the social network website by the first member.

4. The method of claim 1, wherein the content comprises at least one file selected from the group including: (a) at least one multimedia file; (b) at least one video file; (c) at least one audio file; (d) at least one image file; and (d) at least one webpage.

5. The method of claim 1, wherein the existence of the social networking partners relationship that the first member has with the second member is determined by examining data associated with the first member that is stored on the social network and data associated with the second member that is stored on the social network.

6. The method of claim 1, wherein the geographic location of the second member is determined by examining data associated with the second member that is stored on the social network.

7. The method of claim 1, wherein the computer system causes the cached content to expire.

8. The method of claim 1, wherein:
the determining that the first member has a relationship with at least the second member further comprises determining that the first member has a relationship with the second member and a third one of the members such that the first and second members are social networking partners and the first and third members are social networking partners;
the determining a geographic location of the second member further comprises determining a geographic location of the second member and a geographic location of the third member; and
the second storage geographic location where the content is cached is geographically closer to both the determined geographic location of the second member and the determined geographic location of the third member than the first storage geographic location is to either of the determined geographic location of the second member and the determined geographic location of the third member.

9. A computer readable storage medium, tangibly embodying a program of instructions executable by the computer for caching content identified by at least a first member of a social network comprising a plurality of members, the program of instructions, when executing, performing the following steps:
determining, with the computer, that the first member has identified the content, wherein the content identified by the first member is stored at a first storage geographic location;
determining, with the computer, that the first member has a relationship with at least a second member of the social network such that the first and second members are social networking partners;
determining, with the computer, a geographic location of the second member; and
caching with the computer, at a second storage geographic location, the content identified by the first member, wherein the second storage geographic location is geographically closer to the determined geographic location of the second member than the first storage geographic location is to the determined geographic location of the second member.

10. The computer readable storage medium of claim 9, wherein the content is identified by a link posted on a social network website.

11. The computer readable storage medium of claim 10, wherein the link is posted on the social network website by the first member.

12. The computer readable storage medium of claim 9, wherein the content comprises at least one file selected from the group including: (a) at least one multimedia file; (b) at least one video file; (c) at least one audio file; (d) at least one image file; and (d) at least one webpage.

13. The computer readable storage medium of claim 9, wherein the existence of the social networking partners relationship that the first member has with the second member is determined by examining data associated with the first member that is stored on the social network and data associated with the second member that is stored on the social network.

14. The computer readable storage medium of claim 9, wherein the geographic location of the second member is determined by examining data associated with the second member that is stored on the social network.

15. The computer readable storage medium of claim 9, wherein the computer causes the cached content to expire.

16. The computer readable storage medium of claim 9, wherein:
the determining that the first member has a relationship with at least the second member further comprises determining that the first member has a relationship with the second member and a third one of the members such that the first and second members are social networking partners and the first and third members are social networking partners;
the determining a geographic location of the second member further comprises determining a geographic location of the second member and a geographic location of the third member; and
the second storage geographic location where the content is cached is geographically closer to both the determined geographic location of the second member and the determined geographic location of the third member than the first storage geographic location is to either of the determined geographic location of the second member and the determined geographic location of the third member.

17. A computer-implemented system for caching content identified by at least a first member of a social network comprising a plurality of members, the system comprising:
an input element configured to receive data;
a determining element in operative communication with the input element configured to determine, based at least in part upon the received data:
(a) that the first member has identified the content, wherein the content identified by the first member is stored at a first storage geographic location;
(b) that the first member has a relationship with at least a second member of the social network such that the first and second members are social networking partners; and
(c) a geographic location of the second member; and
a caching element in operative communication with the determining element configured to cache, at a second storage geographic location, the content identified by the first member, wherein the second storage geographic location is geographically closer to the determined geographic location of the second member than the first storage geographic location is to the determined geographic location of the second member.

18. The system of claim 17, wherein the content is identified by a link posted on a social network website.

19. The system of claim 18, wherein the link is posted on the social network website by the first member.

20. The system of claim 17, wherein the content comprises at least one file selected from the group including: (a) at least one multimedia file; (b) at least one video file; (c) at least one audio file; (d) at least one image file; and (d) at least one webpage.
